(19) United States
(12) Patent Application Publication
(10) Pub. No.: US 2010/0272949 A1
(43) Pub. Date: Oct. 28, 2010

(54) VACUUM INSULATOR

(75) Inventors: Tae-Ho Song, Daejeon (KR); Choong Hyo Jang, Daejeon (KR); Jae-Sung Kwon, Daejeon (KR); Haeyong Jung, Daejeon (KR)

Correspondence Address: GLOBAL IP COUNSELORS, LLP, 1233 20TH STREET, NW, SUITE 700, WASHINGTON, DC, 20036-2680, US

(73) Assignee: KOREA ADVANCED INSTITUTE OF SCIENCE AND TECHNOLOGY, Daejeon (KR)

(21) Appl. No.: 12/708,328

(22) Filed: Feb. 18, 2010

(30) Foreign Application Priority Data
Apr. 28, 2009 (KR) 10-2009-0037148

(51) Int. Cl. B32B 5/00; E04B 1/74

(52) U.S. Cl. 428/107; 52/407.5

(57) ABSTRACT

A vacuum insulator includes first lateral beams, first longitudinal beams, second lateral beams and second longitudinal beams. The first longitudinal beams are arranged in parallel to one another at a predetermined interval. Each of the first lateral beams has a sectional area alternatively changed to be wide and narrow by the period that is ½ of the interval. The first longitudinal beams are intersected with the first lateral beams at a predetermined angle, and are arranged in parallel to one another at a predetermined interval. Each of the first longitudinal beams has a sectional area alternatively changed to be wide and narrow by the period that is ½ of the interval. Portions with the wide sectional area of each of the first longitudinal beams are attached on portions with the wide sectional area of each of the first lateral beam. The second lateral beams are intersected with the first longitudinal beams, and are arranged in parallel to one another at a predetermined interval at a predetermined angle and are alternately positioned. Each of the second lateral beams has a sectional area alternatively changed to be wide and narrow by the period that is ½ of the interval. Portions with the wide sectional area of each of the second lateral beams are attached on portions with the wide sectional area of each of the first longitudinal beams. The second longitudinal beams are intersected with the second lateral beams at a predetermined angle and are arranged in parallel to one another at a predetermined interval to be alternately positioned with the first longitudinal beams. Each of the second longitudinal beams has a sectional area alternatively changed to be wide and narrow by the period that is ½ of the interval. Portions with the wide sectional area of each of the second longitudinal beams are attached on portions with the wide sectional area of each of the second lateral beams.

### CROSS-REFERENCE TO RELATED APPLICATIONS

This U.S. National stage application claims priority under 35 U.S.C. §119(a) to Korean Patent Application No. 10-2009-0037148, filed in the Republic of Korea on Apr. 28, 2009, the entire contents of which are hereby incorporated herein by reference.

### BACKGROUND OF THE INVENTION

1. Field of the Invention

The present invention relates to a vacuum insulator.

2. Background Information

Currently, human beings are faced with serious problems, i.e., the lack of energy due to exhaustion of fossil fuel resources and the global warming phenomenon caused by emission of carbon dioxide. In addition, studies on the enhancement of energy efficiency currently reach their limitations, and therefore, studies on new energy resources have come into the spotlight as a great concern in energy policy. Accordingly, studies on alternative energy are currently being conducted. However, the supply-and-demand rate of the alternative energy is not more than 1%, and its efficiency is also insufficient. Accordingly, it is necessary to approach such a problem in another direction.

Almost half of the energy consumption amount is currently used for the cooling and heating of buildings. Therefore, it is most important to solve a fundamental problem for energy consumption. If the energy loss in the air-conditioning and heating is decreased by ¼, the problems of the lack of energy and the emission of carbon dioxide, which human beings necessarily undergo, can be simultaneously solved. Thus, a basic and innovative method such as a method of using a vacuum insulator may be most effective in reducing energy loss. If such a vacuum insulator with excellent performance is used, the energy loss can be reduced. If such a vacuum insulator is used, its thickness is decreased, and therefore, internal space in buildings, electronic appliances or storage facilities can be secured as broad as its thickness is decreased. Accordingly, the vacuum insulator can be usefully used to enhance energy efficiency and to make effective use of space.

Meanwhile, a vacuum insulator formed of beams crossing each other has excellent insulation performance. However, such a vacuum insulator has a problem that the load due to atmospheric pressure is not uniformly applied over the whole of the crossed beams. Also, according to the internal structure of a conventional vacuum insulator formed of beams crossing each other, the insulation performance of the vacuum insulator can be lowered due to the conduction heat transmission through the internal structure and the heat resistance in the internal structure. Therefore, such a vacuum insulator has a problem that it can not properly perform its function.

### SUMMARY OF THE INVENTION

The present invention is conceived to solve the aforementioned problems. Accordingly, the present invention provides a vacuum insulator, by which heat resistance can be increased and insulation performance can be simultaneously improved, by alternately changing to be wide and narrow the sectional area of a plurality of lateral and longitudinal beams constituting an internal structure of the vacuum insulator.

The present invention also provides a vacuum insulator, by which the waste of a material can be reduced, by decreasing an unnecessary sectional area at the portion at which a small amount of load is applied to the vacuum insulator.

The present invention also provides a vacuum insulator, in which a heat transfer path can be complicated and insulation performance can be improved, by stacking a plurality of lateral and longitudinal beams constituting the support body in the vacuum insulator to be intersected with each other at a predetermined angle.

The present invention also provides a vacuum insulator, in which the vacuum insulator of the present invention has an insulation performance superior to other vacuum insulators with the same thickness, and energy loss can be reduced and an internal space can be effectively utilized.

A vacuum insulator related to claim 1 includes: first lateral beams arranged in parallel to one another at a predetermined interval, the first lateral beams each having a sectional area alternatively changed to be wide and narrow by the period that is ½ of the interval; first longitudinal beams intersected with the first lateral beams at the predetermined angle and arranged in parallel to one another at a predetermined interval, the first longitudinal beams each having a sectional area alternatively changed to be wide and narrow by the period that is ½ of the interval, wherein portions with the wide sectional area of each of the first longitudinal beams are attached on portions with the wide sectional area of each of the first lateral beams; second lateral beams intersected with the first longitudinal beams at a predetermined angle and arranged in parallel to one another at a predetermined interval to be alternately positioned with the first lateral beams, the second lateral beams each having a sectional area alternatively changed to be wide and narrow by the period that is ½ of the interval, wherein portions with the wide sectional area of each of the second lateral beams are attached on portions with the wide sectional area of each of the first longitudinal beams; and second longitudinal beams intersected with the second lateral beams at a predetermined angle and arranged in parallel to one another at a predetermined interval to be alternately positioned with the first longitudinal beams, the second longitudinal beams each having a sectional area alternatively changed to be wide and narrow by the period that is ½ of the interval, wherein portions with the wide sectional area of each of the second longitudinal beams are attached on portions with the wide sectional area of each of the second lateral beams.

Consequently, according to the vacuum insulator related to claim 1, since the sectional area of a plurality of lateral and longitudinal beams constituting an internal structure of the vacuum insulator is changed to be wide and narrow, heat resistance can be increased and insulation performance can be simultaneously improved. Also, since an unnecessary sectional area at the portion at which a small amount of load is applied to the vacuum insulator is decreased, the waste of a material can be reduced. Also, since a plurality of lateral and longitudinal beams constituting the support body in the vacuum insulator to be intersected with each other at a predetermined angle are stacked, a heat transfer path can be complicated and insulation performance can be improved.

A vacuum insulator related to claim 2 further includes: third lateral beams intersected with the second longitudinal beams at a predetermined angle and arranged in parallel to one another at a predetermined interval, the third lateral beams each having a sectional area alternatively changed to be wide and narrow by the period that is ½ of the interval, wherein portions with the wide sectional area of each of the third lateral beams are attached on portions corresponding to the first lateral beam in the portions with the wide sectional area of each of the second longitudinal beams; and third longitudinal beams intersected at a predetermined angle and arranged in parallel to one another at a predetermined interval, the third longitudinal beams each having a sectional area alternatively changed to be wide and narrow by the period that is ½ of the interval, wherein portions with the wide sectional area of each of the third longitudinal beams are attached on portions corresponding to the first longitudinal beam in the portions with the wide sectional area of each of the third lateral beams.

Consequently, according to the vacuum insulator related to claim 2, since the sectional area of a plurality of lateral and longitudinal beams constituting an internal structure of the vacuum insulator is changed to be wide and narrow, heat resistance can be increased and insulation performance can be simultaneously improved. Also, since an unnecessary sectional area at the portion at which a small amount of load is applied to the vacuum insulator is decreased, the waste of a material can be reduced. Also, since a plurality of lateral and longitudinal beams constituting the support body in the vacuum insulator to be intersected with each other at a predetermined angle are stacked, a heat transfer path can be complicated and insulation performance can be improved.

According to the present invention configured as described above, since the sectional area of a plurality of lateral and longitudinal beams constituting an internal structure of the vacuum insulator is changed to be wide and narrow, heat resistance can be increased and insulation performance can be simultaneously improved.

According to the present invention, since an unnecessary sectional area at the portion at which a small amount of load is applied to the vacuum insulator is decreased, the waste of a material can be reduced.

According to the present invention, since a plurality of lateral and longitudinal beams constituting the support body in the vacuum insulator to be intersected with each other at a predetermined angle are stacked, a heat transfer path can be complicated and insulation performance can be improved.

According to the present invention, the vacuum insulator of the present invention has an insulation performance superior to other vacuum insulators with the same thickness, and energy loss can be reduced and an internal space can be effectively utilized.

The objects, constructions and effects of the present invention are included in the following embodiments and drawings. The advantages, features, and achieving methods of the present invention will be more apparent from the following detailed description in conjunction with embodiments and the accompanying drawings. The same reference numerals are used throughout the drawings to refer to the same or like parts.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a perspective drawing describing the structure of a vacuum insulator according to an embodiment of the present invention;

FIGS. 2a and 2b are a top drawing and an enlarged drawing describing the structure of the vacuum insulator according to an embodiment of the present invention;

FIG. 3 is a drawing describing the force applied to a unit beam constituting the vacuum insulator according to an embodiment of the present invention; and

FIG. 4 is a graph describing the relation between the shear force and bending moment of a plurality of lateral and longitudinal beams constituting a vacuum insulator according to an embodiment of the present invention.

### DETAILED DESCRIPTION OF THE PREFERRED EMBODIMENTS

Hereinafter, exemplary embodiments of the present invention will be described in detail with reference to the accompanying drawings. However, the present invention is not limited to the embodiments but may be implemented into different forms. These embodiments are provided only for illustrative purposes and for full understanding of the scope of the present invention by those skilled in the art.

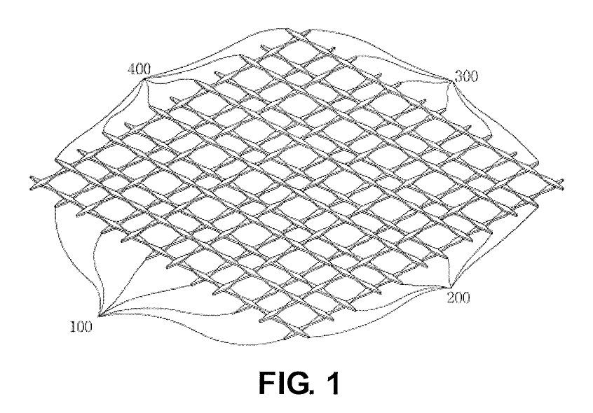

FIG. 1 is a perspective drawing describing the structure of a vacuum insulator according to an embodiment of the present invention.

As shown in FIG. 1, the structure of the vacuum insulator according to the embodiment of the present invention is a structure in which first lateral beams 100, first longitudinal beams 200, second lateral beams 300 and second longitudinal beams 400 are sequentially attached.

Meanwhile, the most optimized structure of the vacuum insulator is a structure in which the allowance stress of a material is applied over the internal structure of the vacuum insulator. Like the structure of the vacuum insulator according to the present invention, in the vacuum insulator including beams with a changeable sectional area, which cross each other, since an unnecessary sectional area at a portion to which a small amount of load is applied is decreased, waste of a material can be reduced. Like the structure of the vacuum insulator according to the present invention, if the maximum allowance load is applied over the internal structure of the vacuum insulator, since heat resistance is increased by the changeable sectional area, thermal insulation performance can be improved.

The first lateral beams 100 are arranged in parallel to one another at a predetermined interval, and the sectional area of each of the first lateral beams 100 is alternately changed to be wide and narrow by the period that is ½ of the interval.

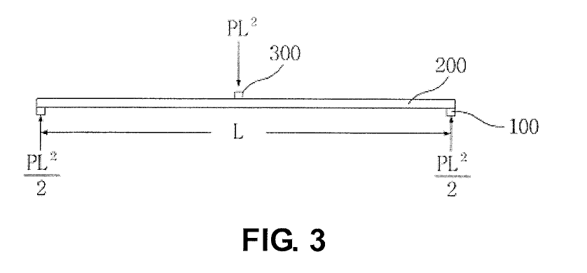

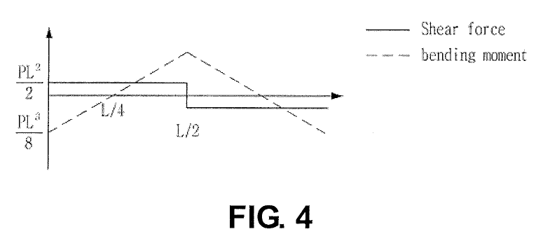

The first longitudinal beams 200 are intersected with the first lateral beams 100 at a predetermined angle. The first longitudinal beams 200 are arranged in parallel to one another at a predetermined interval. The sectional area of each of the first longitudinal beams 200 is alternately changed to be wide and narrow by the period that is ½ of the interval. Portions with the wide sectional area of each of the first longitudinal beams 200 are attached on portions with the wide sectional area of each of the first lateral beams 100. In the present invention, since the wide sectional area and the narrow sectional area of each of the beams are alternately repeated by the period that is ½ of the interval, heat resistance generated by the change in sectional area can be increased. Also, since the sectional area at the attached portion is increased, the bending moment that is forced to the attached portion can be supported. The bending moment will be described in detail with reference to FIGS. 3 and 4.

The second lateral beams 300 are intersected with the first longitudinal beams 200 at a predetermined angle. The second lateral beams 300 are arranged in parallel to one another at a predetermined interval to be alternately positioned with the first lateral beams 100. The sectional area of each of the second lateral beams 300 is alternately changed to be wide and narrow by the period that is ½ of the interval. Portions with the wide sectional area of each of the second lateral beams 300 are attached on portions with the wide sectional area of each of the first longitudinal beams 200.

The second longitudinal beams 400 are intersected with the second lateral beams 300 at a predetermined angle. The second longitudinal beams 400 are arranged in parallel to one another at a predetermined interval to be alternately positioned with the first longitudinal beams 200. The sectional area of each of the second longitudinal beams 400 is alternately changed to be wide and narrow by the period that is ½ of the interval. Portions with the wide sectional area of each of the second longitudinal beams 400 are attached on portions with the wide sectional area of each of the second lateral beams 300.

Meanwhile, although not shown in this figure, in the structure of the vacuum insulator shown in FIG. 1, third lateral beams may be further attached on the second longitudinal beams 400, and third longitudinal beams may be further attached on the third lateral beams.

At this time, the third lateral beams are intersected with the second longitudinal beams 400 at a predetermined angle. The third lateral beams are arranged in parallel to one another at a predetermined interval. The sectional area of each of the third lateral beams 300 is alternately changed to be wide and narrow by the period that is ½ of the interval. Portions with the wide sectional area of each of the third lateral beams are attached on portions corresponding to the first lateral beam 100 in the portions with the wide sectional area of each of the second longitudinal beams 400.

The third longitudinal beams are intersected with the third lateral beams at a predetermined angle. The third longitudinal beams are arranged in parallel to one another at a predetermined interval. The sectional area of each of the third longitudinal beams is alternately changed to be wide and narrow by the period that is ½ of the interval. Portions with the wide sectional area of each of the third longitudinal beams are attached on portions corresponding to the first longitudinal beam 200 in the portions with the wide sectional area of each of the third lateral beams.

The reason why the sectional area of each of the beams is formed by the ½ of the period even when the third lateral beams and the third longitudinal beams are attached is identical to that in the first lateral beams 100 and the second lateral beams 300 and the first longitudinal beams 200 and the second longitudinal beams 400.

For the same reason, since a plurality of beams (fourth lateral beams, fourth longitudinal beams and the like) are stacked on the third longitudinal beams, heat resistance between beams can be increased and thermal insulation performance can be improved.

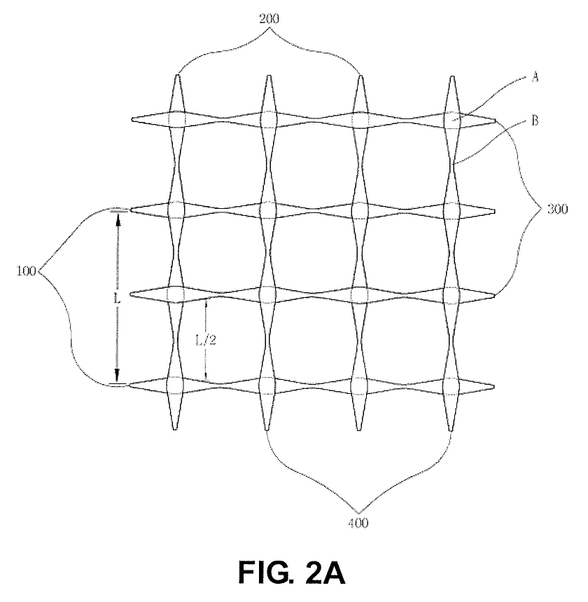

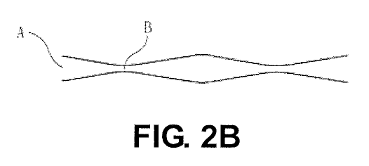

FIGS. 2a and 2b are a top drawing and an enlarged drawing describing the structure of the vacuum insulator according to an embodiment of the present invention.

As shown in FIGS. 2a and 2b, in the vacuum insulator according to the embodiment of the present invention, the first lateral beams 100 are arranged in parallel to one another at a predetermined interval. Each of the first lateral beams 100 has a sectional area alternately changed to be wide A and narrow B by the period L/2 that is ½ of the interval L between the adjacent beams. The first longitudinal beams 200 are intersected with the first lateral beams 100 at a predetermined angle and attached on the first lateral beams 100. Each of the first longitudinal beams 200 has a sectional area alternately changed to be wide and narrow by the period L/2 that is ½ of the interval L between the adjacent beams. Here, the position A at which the first longitudinal beam 200 is attached to the first lateral beam 100 is a position at which the portion having the wide sectional area of the first longitudinal beam 200 is engaged with the portion having the wide sectional area of the first lateral beam 100. At the position A, the first longitudinal beam 200 is attached on the first lateral beam 100 to be intersected with each other. The second lateral beams 300 are attached on the first longitudinal beams 200 to be intersected with each other. Here, the position A at which the second lateral beam 300 is attached to the first longitudinal beam 200 is a position at which the portion having the wide sectional area of the second lateral beam 300 is engaged with the part having the wide sectional area of the first longitudinal beam 200. At the position A, the second lateral beam 300 is attached on the first longitudinal beam 200 to be intersected with each other. The second lateral beams 300 are arranged in parallel to the first lateral beams 100. Also, the second lateral beams 300 are arranged at the center between adjacent first lateral beams 100. Similarly, the second longitudinal beams 400 are attached on the second lateral beams 300 to be intersected with each other. The second longitudinal beams 400 are attached on the second lateral beam 300 to be intersected with each other. The second longitudinal beams 400 are arranged in parallel to the first longitudinal beams 200 and at the center between adjacent first longitudinal beams 200.

Here, the position A at which the first lateral beam 100, the first longitudinal beam 200, the second lateral beam 300 and the second longitudinal beam 400 are sequentially attached to one another is necessarily wide because the beam of the position A is easily broken by bending. For example, the greatest bending moment is forced to the attached position between the first lateral beams 100 and the first longitudinal beam 200, and to the attached position between the first longitudinal beam 200 and the second lateral beams 300. Since the sectional area of each of the beams is formed to be wide at the attached position A, the bending moment that is forced to the attached portion can be supported.

FIG. 3 is a drawing describing the force applied to a unit beam constituting the vacuum insulator, and the like according to an embodiment of the present invention.

In order to describe how the force is applied to the unit beam, the structure in which the first lateral beam 100, the first longitudinal beam 200 and the second lateral beam 300 are sequentially attached to one another is shown as an example in FIG. 3. It is assumed that the interval between the first lateral beams 100 is L, and the bending moment forced to an upper surface of the second lateral beam 300 is PL². Here, the interval L also refers to the period by which the sectional area of the first longitudinal beam 200 is changed. The second lateral beam 300 attached on the central portion of the first longitudinal beam 200 will be described as an example.

Meanwhile, the bending moment refers to a force that intends to bend a beam when a vertical load is applied on the beam. At this time, shear forces forced so that both end portions of the beam cross each other are dislocated respectively.

Accordingly, for the bending moment forced to the upper surface of the second lateral beam 300, the bending moment PL² is forced to the central portion of the second lateral beam 300, and the shear forces PL²/2 are forced to both ends portions of the first longitudinal beam 200 beneath the second lateral beam 300.

According to the vacuum insulator, the greatest bending moment is forced to the position at which the second lateral beam 300 is attached to the first longitudinal beam 200. Therefore, for the bending moment forced to the second lateral beam 300, since the sectional area of the beam positioned at the position that becomes ½ of L, i.e., one period of the first longitudinal beam 200 is widened so that the first longitudinal beam 200 attached beneath the second lateral beam 300 is not broken, the vertical load can be supported.

FIG. 4 is a graph describing the relation between the shear force and bending moment of a plurality of lateral and longitudinal beams constituting a vacuum insulator according to an embodiment of the present invention.

As shown in FIG. 4, the shear force and bending moment are forced to the plurality of lateral and longitudinal beams constituting the vacuum insulator according to the embodiment of the present invention. The graph shown in FIG. 4 is used to compare the relation between the shear force and bending moment although their units are different from each other. Meanwhile, the amplitude of the bending moment is greater than that of the shear force.

Here, it can be seen that the bending moment with the greatest amplitude is forced to the central portion of a beam, and the bending moments with the smallest amplitude are forced to both ends of the beam, respectively. Also, it can be seen that the shear forces that are forced in parallel and in opposite directions at both ends of the beam is zero at the central portion of the beam. The bending moment is zero at the position that is ¼ of the period of the beam, and only the sectional area for simply supporting the shear force is necessary at the position. Therefore, at the position at which the lateral and longitudinal beams constituting the vacuum insulator are attached to each other, sectional area of the beams may be widened so that the lateral and longitudinal beams are not broken by the bending moment forced from the upper side of the attached position.

Meanwhile, although not shown in these figures, the outsides of the vacuum insulator are respectively covered by two upper and lower plates of which surfaces are formed flat. Also, the outside of the upper and lower plates are covered by an envelope. Here, the envelope functions to prevent air infiltration from the exterior to the interior of the vacuum insulator. Therefore, the envelope of low air permeability may be used so as to maintain the vacuum level for a long period of time. Also, the envelope may include a film formed by stacking polyethylene terephthalate (PET), lowdensity polyethylene (LDPE), aluminum and linear-lowdensity polyethylene (LLDPE), which is generally used as a vacuum packing material.

According to the vacuum insulator configured as described above, since the sectional area of a plurality of lateral and longitudinal beams constituting an internal structure of the vacuum insulator is changed to be wide and narrow, heat resistance can be increased and insulation performance can be simultaneously improved. According to the present invention, since an unnecessary sectional area at the portion at which a small amount of load is applied to the vacuum insulator is decreased, the waste of a material can be reduced. According to the present invention, since a plurality of lateral and longitudinal beams constituting the support body in the vacuum insulator to be intersected with each other at a predetermined angle are stacked, a heat transfer path can be complicated and insulation performance can be improved. According to the present invention, the vacuum insulator of the present invention has an insulation performance superior to other vacuum insulators with the same thickness, and energy loss can be reduced and an internal space can be effectively utilized.

As described above, a technical composition of the present invention is to be understood that one skilled in the art is not to modify a technical idea or an essential feature of the present invention but to take effect as the other concrete embodiments.

Therefore, it is to be understood that embodiments described above are not qualifying but exemplary in all points. Also, the scope of the present invention will be included in the following claims than above detail explanation, and it is to be analyzed that the meaning and scope of the claims and all changes deducted from equivalent arrangements or modifications included within the scope of the present invention.

What is claimed is:

1. A vacuum insulator comprising:
first lateral beams configured to be arranged in parallel to one another at a predetermined interval, the first lateral beams each having a sectional area alternatively changed to be wide and narrow by the period that is ½ of the predetermined interval;
first longitudinal beams configured to be intersected with the first lateral beams at a predetermined angle and be arranged in parallel to one another at a predetermined interval, the first longitudinal beams each having a sectional area alternatively changed to be wide and narrow by the period that is ½ of the interval, wherein portions with the wide sectional area of each of the first longitudinal beams are attached on portions with the wide sectional area of each of the first lateral beams;
second lateral beams configured to be intersected with the first longitudinal beams at a predetermined angle and be arranged in parallel to one another at a predetermined interval to be alternately positioned with the first lateral beams, the second lateral beams each having a sectional area alternatively changed to be wide and narrow by the period that is ½ of the interval, wherein portions with the wide sectional area of each of the second lateral beams are attached on portions with the wide sectional area of each of the first longitudinal beams; and
second longitudinal beams configured to be intersected with the second lateral beams at a predetermined angle and be arranged in parallel to one another at a predetermined interval to be alternately positioned with the first longitudinal beams, the second longitudinal beams each having a sectional area alternatively changed to be wide and narrow by the period that is ½ of the interval, wherein portions with the wide sectional area of each of the second longitudinal beams are attached on portions with the wide sectional area of each of the second lateral beams.

2. The vacuum insulator as set forth in claim 1 further comprising:
third lateral beams configured to be intersected with the second longitudinal beams at a predetermined angle and be arranged in parallel to one another at a predetermined interval, the third lateral beams each having a sectional area alternatively changed to be wide and narrow by the period that is ½ of the interval, wherein portions with the wide sectional area of each of the third lateral beams are attached on portions corresponding to the first lateral beam in the portions with the wide sectional area of each of the second longitudinal beams; and
third longitudinal beams configured to be intersected with the third lateral beams at a predetermined angle and be arranged in parallel to one another at a predetermined interval, the third longitudinal beams each having a sectional area alternatively changed to be wide and narrow by the period that is ½ of the interval, wherein portions with the wide sectional area of each of the third longitudinal beams are attached on portions corresponding to the first longitudinal beam in the portions with the wide sectional area of each of the third lateral beams.
